(19) United States
(12) Patent Application Publication
(10) Pub. No.: US 2015/0379483 A1
(43) Pub. Date: Dec. 31, 2015

(54) DYNAMIC CURRENCY CONVERSION TRANSACTION SYSTEM

(71) Applicant: PURE COMMERCE PTY LIMITED, Sydney, New South Wales (AU)

(72) Inventor: Sunil Sharma, Sydney (AU)

(73) Assignee: Pure Commerce Pty Limited, Sydney, New South Wales (AU)

(21) Appl. No.: 14/768,200

(22) PCT Filed: Mar. 14, 2014
(86) PCT No.: PCT/IB2014/000343

§ 371 Date: Aug. 14, 2015

(30) Foreign Application Priority Data
Mar. 14, 2013 (AU) 2013900873

(51) Int. Cl. G06Q 20/08; G06Q 20/40

(52) U.S. Cl. CPC G06Q 20/08; G06Q 20/405

(57) ABSTRACT

The invention disclosed is a computer implemented method of performing a payment device transaction between a payment device holder and a merchant. The steps include, obtaining a transaction amount of the transaction in a merchant's currency, and then obtaining an issuer currency from data present on the payment device, using several direct or indirect techniques. If an issuer currency is found and is not the same as the merchant currency then the transaction amount is converted to the issuer currency using an exchange rate source. If no data can be extracted from the payment device, then equivalent amounts in a range of currencies to the transaction amount are obtained and displayed for the user to choose from. Against each currency displayed is a graphic that uniquely identifies each currency. A transaction currency can then be chosen and the transaction completed.

### TECHNICAL FIELD OF THE INVENTION

This invention relates to electronic payment services and to electronic payment networks, systems and methods for managing electronic transfer of funds between different entities or accounts. The invention has a particular, but not sole, application in processing transactions using smart devices including Integrated Circuit Card (ICC) payment card transactions with currency conversion.

### BACKGROUND OF THE INVENTION

Recently smart devices, such as smartphones, tablets and similar have included an onboard application or software, including supporting hardware (for example a near field chip “NFC”) that allows the device holder (for example its owner) to maintain an electronic wallet (“ewallet”) onboard the device. Essentially this can be thought of as a debit or credit card or similar enabled by the application and hardware in the device. Such an ewallet can hold one or more types and brands of card and the data and information usually contained in the card. In discussions below the word card could mean therefore an actual card, for example a credit card, or the virtual form or that stored in the ewallet of a device.

Payment systems for cards are well known. In recent times there has been a move toward offering a financial service to card and device holders in payment transactions using the device or card in which the device holders have the cost of transactions converted to their local currency when making payment in a foreign currency. This service is sometimes referred to as Dynamic Currency Conversion (DCC).

DCC services have a number of advantages, including:
the visibility of charges made in foreign countries or currencies;
the ability to enter expenses more easily (for business travelers);
a comparable or less expensive fee than the currency conversion rates charged by credit card companies, and
freedom of choice of currency by the user.

Known methods for processing such a payment transaction with currency conversion are discussed below. Further information on such payment systems is provided later in this document.

The normal steps for processing a payment card transaction with currency exchange are:
1. obtain the payment device (for example a credit card or device with an ewallet) from the customer;
2. swipe or locate the payment device on or near the device reader (for example a payment terminal) to extract the card number (sometimes referred to as the track 2 data). Alternatively enter the card number manually;
3. determine the card issuer currency from the card number for a potential exchange transaction;
4a. if the card is determined to be foreign, convert local amount into foreign amount;
4b. solicit customer choice (whether the customer wants to proceed with the converted amount or to have the transaction proceed in the normal fashion); and
5. process the payment transaction in the chosen currency and print receipt.

Steps 1, 2 and 5 always occur, regardless of whether currency exchange is involved or not (step 5 defaults to merchant's local currency in this case). With manual currency exchange, steps 3 and 4 are performed manually, and are candidates for computerization. Step 4b, in fact stays manual even after computerization, in the sense that the operator or terminal has to prompt the customer to express the choice by pressing a button somewhere. In one attempt of automation of these steps (disclosed in NZ published patent specification 517105) a map of card prefixes vs. currency is provided in the hand held terminal along with the currency versus conversion rate. A search through these files must be performed while the transaction is in progress, so that the currency of the card can be determined on the fly, and automatically offer a choice to the customer.

The information relating to card number prefixes or bank identification numbers (BINs), and corresponding currency symbols is generally organized in terms of tables similar to the following:

456789 AUD
432198 GBP
. . .
. . .
567890 EUR

The above table means that if a card number starts with 456789, it was issued by an Australian Bank, so a transaction currency choice of Australian Dollars should be offered. Similarly, if the card number starts with 432198, the choice should be offered in British Pounds, and if it starts with 567890, in Euros, and so on and so forth.

Card schemes often issue entire ranges of BINs to large banks. For example, all BINs in the range 432198 to 432210 might belong to a single British bank. So rather than having 13 consecutive entries for GBP, a table can have a single range entry as follows:

456789 AUD
432198-210 GBP
. . .
567890 EUR

This table, with mixed single entries and range entries is more efficient than the previous table in terms of saving in storage space and speed of search.

In view of the fact that there are hundreds of thousands of such entries to be loaded on a point of sale terminal, a lot of memory space must be reserved for it. In view of the fact that these entries have to be searched through while a transaction is in progress, substantial computing power is required to ensure there is no latency in the progress of the transaction. While these issues are not very important on high powered server and desktop machines with memory space running into gigabytes, and processor speeds running into several gigahertz, they become important issues for standard hand held payment terminals routinely seen in shopping malls.

In another approach published in NZ Patent No. 554222, an authorization request is transmitted over the payment network, and the information received from that request is used to determine the card currency (i.e. the issuer currency of the card). A difficulty with this approach is that the currency may not be immediately apparent.

With ICC cards, there is also the added complexity of efficiently handling a DCC transaction integrating where necessary both the data and software on the card together with that of the acquirer network.

In this specification where reference has been made to patent specifications, other external documents, or other sources of information, this is generally for the purpose of providing a context for discussing the features of the invention. Unless specifically stated otherwise, reference to such external documents is not to be construed as an admission that such documents, or such sources of information, in any jurisdiction, are prior art, or form part of the common general knowledge in the art.

### OBJECT OF THE INVENTION

It is therefore an object of the present invention to provide an Integrated Circuit Card (ICC) transaction method or system which provides an improved Dynamic Currency Conversion (DCC) method or system for card transactions, or at least which provides the public with a useful alternative to existing transaction methods or systems.

### BRIEF SUMMARY OF THE INVENTION

In a first aspect the present invention may be said to broadly consist in a computer implemented method of performing a payment device transaction between a payment device holder and a merchant, the method comprising or including,
a) obtaining a transaction amount of the transaction in a merchant's currency,
b) obtaining,
   a. an issuer currency from data present on said payment device, and if said issuer currency is not the same as said merchant currency, then obtaining an equivalent amount to said transaction amount in at least said issuer currency using at least one exchange rate source; or
   b. a range of payment currencies, if no data can be extracted from said payment device, then obtaining equivalent amounts to said transaction amount in at least said range of payment currencies using at least one exchange rate source,
c) allowing a choice of transaction currency to be made for said transaction from a displayed currency or currencies, by displaying said transaction amount or equivalent amount(s) in any one or more of said,
   a. issuer currency,
   b. merchant currency, or
   c. range of payment currencies,
wherein displayed against each said displayed currency or currencies is a graphic that uniquely identifies that currency.

Preferably said graphic is chosen from any one or more of a,
a flag,
an emblem,
a logo,
   that substantially uniquely identifies the country or countries of origin of said currency.

Preferably said graphic is a flag, or is derived from a flag of the country of origin, of said currency.

Preferably the step of obtaining said issuer currency relies only on said data present on said payment device, and does not need to contact a network outside of said payment device holder and a merchant's device.

Preferably the step of obtaining said issuer currency uses data from said payment device that does not directly identify said issuer currency and subjects said data to heuristics to identify said issuer currency based on the way or ways in which said data is packed, presented, or otherwise, that is indirectly indicative of said issuer currency.

Preferably said graphic is displayed in colour for a user to choose from.

Preferably said user is said payment device holder.

Alternatively said user is said merchant.

Preferably said device is any one or more of,
A payment card (whether credit, debit, or otherwise),
An Integrated Chip Card (“ICC”), or
Smartdevice (for example a phone, tablet, or similar).

Preferably in addition to said issuer currency and said merchant currency, one or more additional major currencies are shown to choose from, different to said issuer currency and said merchant currency.

Preferably said additional major currencies are at least any one or more of the following,
United States Dollar,
European Euro,
British Pound,
Japanese Yen,
Australian Dollar,
Canadian Dollar,
Swiss Francs,
Hong Kong Dollars,
Chinese Yuan,
Korean Won, and
Singapore Dollar.

Preferably said step of obtaining said issuer currency includes the steps of searching said data for one or more predetermined fields and retrieving said data relating to one or more of said fields.

Preferably said fields include at least any one or more of,
A country phone code,
A country geographical code,
A currency code,
Currency name,
Country name,
Issuer name,
Issuer Phone,
Issuer Address, or
Billing address.

Preferably said step of obtaining said issuer currency includes the step of identifying the issuer currency from one or more of said fields that directly identify the issuer currency.

Preferably said range of payment currencies allows a user to scroll through numerous currencies in said equivalent amount until they find a said transaction currency they wish to use.

Preferably said method includes the step of allowing said device holder to confirm said transaction currency once chosen.

Preferably said method includes the step of still providing said transaction amount in the issuer currency to said device holder prior to receiving confirmation of said transaction from said device holder.

Preferably said method includes said device authorizing said transaction, or requesting authorization from an acquirer, which said acquirer will ultimately settle said transaction with said merchant.

Preferably said method includes said device generating a cryptogram for forwarding to said acquirer for authorization.

Preferably said method includes the step of providing said device holder with an opportunity to instead proceed with the transaction in said merchant currency after said issuer currency has been selected as said transaction currency.

Preferably said method includes the step of providing said transaction amount to said device holder in said transaction currency prior to completion of said transaction.

Preferably said updated exchange rate source is updated automatically from at least one exchange rate server.

Alternatively said updated exchange rate server is updated manually.

In another aspect the present invention may be said to broadly consist in a computer implemented method of performing an Integrated Circuit Card (ICC) transaction between a card holder and a merchant, the method comprising or including the steps of:
a) obtaining a transaction amount of the transaction in a merchant's currency,
b) obtaining,
   a. an issuer currency from data present on said ICC, and if said issuer currency is not the same as said merchant currency, then obtaining an equivalent amount to said transaction amount in at least said issuer currency using at least one exchange rate source; or
   b. a range of payment currencies, if no data can be extracted from said ICC, then obtaining equivalent amounts to said transaction amount in at least said range of payment currencies using at least one exchange rate source,
c) allowing a choice of transaction currency to be made for said transaction from a displayed currency or currencies, by displaying said transaction amount or equivalent amount(s) in any one or more of said,
   a. issuer currency,
   b. merchant currency, or
   c. range of payment currencies,
wherein displayed against each said displayed currency or currencies is a graphic that uniquely identifies that currency.

In another aspect the present invention may be said to broadly consist in a computer implemented method of performing a card transaction between a card holder and a merchant, the method comprising or including the steps of:
a) obtaining a transaction amount of the transaction in a merchant's currency,
b) obtaining,
   a. an issuer currency from data present on said card, and if said issuer currency is not the same as said merchant currency, then obtaining an equivalent amount to said transaction amount in at least said issuer currency using at least one exchange rate source; or
   b. a range of payment currencies, if no data can be extracted from said card, then obtaining equivalent amounts to said transaction amount in at least said range of payment currencies using at least one exchange rate source,
c) allowing a choice of transaction currency to be made for said transaction from a displayed currency or currencies, by displaying said transaction amount or equivalent amount(s) in any one or more of said,
   a. issuer currency,
   b. merchant currency, or
   c. range of payment currencies,
wherein displayed against each said displayed currency or currencies is a graphic that uniquely identifies that currency.

In another aspect the present invention may be said to broadly consist in a computer operated program adapted to run on a computer device to perform a payment device transaction between a payment device holder and a merchant, the method comprising or including,
a) obtaining a transaction amount of the transaction in a merchant's currency,
b) obtaining,
   a. an issuer currency from data present on said payment device, and if said issuer currency is not the same as said merchant currency, then obtaining an equivalent amount to said transaction amount in at least said issuer currency using at least one exchange rate source; or
   b. a range of payment currencies, if no data can be extracted from said payment device, then obtaining equivalent amounts to said transaction amount in at least said range of payment currencies using at least one exchange rate source,
c) allowing a choice of transaction currency to be made for said transaction from a displayed currency or currencies, by displaying said transaction amount or equivalent amount(s) in any one or more of said,
   a. issuer currency,
   b. merchant currency, or
   c. range of payment currencies,
wherein displayed against each said displayed currency or currencies is a graphic that uniquely identifies that currency.

In another aspect the present invention may be said to broadly consist in a computer device to implement a method of performing a payment device transaction between a payment device holder and a merchant, said computer device to carry out the following steps, comprising or including,
a) obtaining a transaction amount of the transaction in a merchant's currency,
b) obtaining,
   a. an issuer currency from data present on said payment device, and if said issuer currency is not the same as said merchant currency, then obtaining an equivalent amount to said transaction amount in at least said issuer currency using at least one exchange rate source; or
   b. a range of payment currencies, if no data can be extracted from said payment device, then obtaining equivalent amounts to said transaction amount in at least said range of payment currencies using at least one exchange rate source,
c) allowing a choice of transaction currency to be made for said transaction from a displayed currency or currencies, by displaying said transaction amount or equivalent amount(s) in any one or more of said,
   a. issuer currency,
   b. merchant currency, or
   c. range of payment currencies,
wherein displayed against each said displayed currency or currencies is a graphic that uniquely identifies that currency.

In another aspect the present invention may be said to broadly consist in a system for implementing a method of performing a payment device transaction between a payment device holder and a merchant, to carry out the following steps comprising or including,
a) obtaining a transaction amount of the transaction in a merchant's currency,
b) obtaining,
   a. an issuer currency from data present on said payment device, and if said issuer currency is not the same as said merchant currency, then obtaining an equivalent amount to said transaction amount in at least said issuer currency using at least one exchange rate source; or
   b. a range of payment currencies, if no data can be extracted from said payment device, then obtaining equivalent amounts to said transaction amount in at least said range of payment currencies using at least one exchange rate source,
c) allowing a choice of transaction currency to be made for said transaction from a displayed currency or currencies, by displaying said transaction amount or equivalent amount(s) in any one or more of said,
   a. issuer currency,
   b. merchant currency, or
   c. range of payment currencies,
wherein displayed against each said displayed currency or currencies is a graphic that uniquely identifies that currency.

In another aspect the present invention may be said to broadly consist in a method of performing a payment device transaction between a payment device holder and a merchant, the method comprising or including,
a) obtaining a transaction amount of the transaction in a merchant's currency,
b) obtaining,
   a. an issuer currency from data present on said payment device, and if said issuer currency is not the same as said merchant currency, then obtaining an equivalent amount to said transaction amount in at least said issuer currency using at least one exchange rate source; or
   b. a range of payment currencies, if no data can be extracted from said payment device, then obtaining equivalent amounts to said transaction amount in at least said range of payment currencies using at least one exchange rate source,
c) allowing a choice of transaction currency to be made for said transaction from a displayed currency or currencies, by displaying said transaction amount or equivalent amount(s) in any one or more of said,
   a. issuer currency,
   b. merchant currency, or
   c. range of payment currencies,
wherein displayed against each said displayed currency or currencies is a graphic that uniquely identifies that currency.

In a further aspect the invention broadly consists in a system for performing an ICC card transaction between a card holder and a merchant, the system including one or more processors programmed and operable to perform the method as set forth in any one of the preceding statements.

In a further aspect the invention broadly consists in a system for determining a transaction currency for an ICC transaction between a card holder and merchant, the system including one or more processors programmed and operable to perform the method as set forth in any one of the preceding statements.

In a further aspect the present invention may be said to broadly consist in a computer implemented method of performing a payment device transaction as herein described with reference to any one or more of the accompanying drawings.

In a further aspect the present invention may be said to broadly consist in a computer implemented method of performing an Integrated Circuit Card (ICC) transaction as herein described with reference to any one or more of the accompanying drawings.

In a further aspect the present invention may be said to broadly consist in a computer implemented method of performing a card transaction as herein described with reference to any one or more of the accompanying drawings.

In a further aspect the present invention may be said to broadly consist in a computer operated program as herein described with reference to any one or more of the accompanying drawings.

In a further aspect the present invention may be said to broadly consist in a computer device as herein described with reference to any one or more of the accompanying drawings.

In a further aspect the present invention may be said to broadly consist in a system for implementing a method of performing a payment device transaction as herein described with reference to any one or more of the accompanying drawings.

In a further aspect the present invention may be said to broadly consist in a method of performing a payment device transaction as herein described with reference to any one or more of the accompanying drawings.

As used herein the term “and/or” means “and” or “or”, or both.

As used herein “(s)” following a noun means the plural and/or singular forms of the noun.

The term “comprising” as used in this specification means “consisting at least in part of”. When interpreting statements in this specification which include that term, the features, prefaced by that term in each statement, all need to be present, but other features can also be present. Related terms such as “comprise” and “comprised” are to be interpreted in the same manner.

It is intended that reference to a range of numbers disclosed herein (for example, 1 to 10) also incorporates reference to all rational numbers within that range (for example, 1, 1.1, 2, 3, 3.9, 4, 5, 6, 6.5, 7, 8, 9 and 10) and also any range of rational numbers within that range (for example, 2 to 8, 1.5 to 5.5 and 3.1 to 4.7).

The entire disclosures of all applications, patents and publications, cited above and below, if any, are hereby incorporated by reference.

This invention may also be said broadly to consist in the parts, elements and features referred to or indicated in the specification of the application, individually or collectively, and any or all combinations of any two or more of said parts, elements and features, and where specific integers are mentioned herein which have known equivalents in the art to which this invention relates, such known equivalents are deemed to be incorporated herein as if individually set forth.

Further aspects of the invention will become apparent from the following description.

### BRIEF DESCRIPTION OF THE DRAWINGS

One of more embodiments of the invention will be described below with reference to the accompanying drawings, in which,

FIG. 1: is a front view of a credit card,

FIG. 2: is a rear view of a card of FIG. 1,

FIG. 3: is a front view of a smart device,

FIG. 4: is a perspective view of a device payment terminal,

FIG. 5: is a schematic diagram of a Global Payment Network,

FIG. 6: is a flow chart illustrating operation of the present invention,

FIG. 7: is a screen shot of an optional screen asking the user to identify the Issuer country (and therefore currency) of their device, and

FIG. 8: is a screen shot of a range of currencies which have been converted to the equivalent transaction amount, from which a user can then choose.

### DETAILED DESCRIPTION OF THE INVENTION

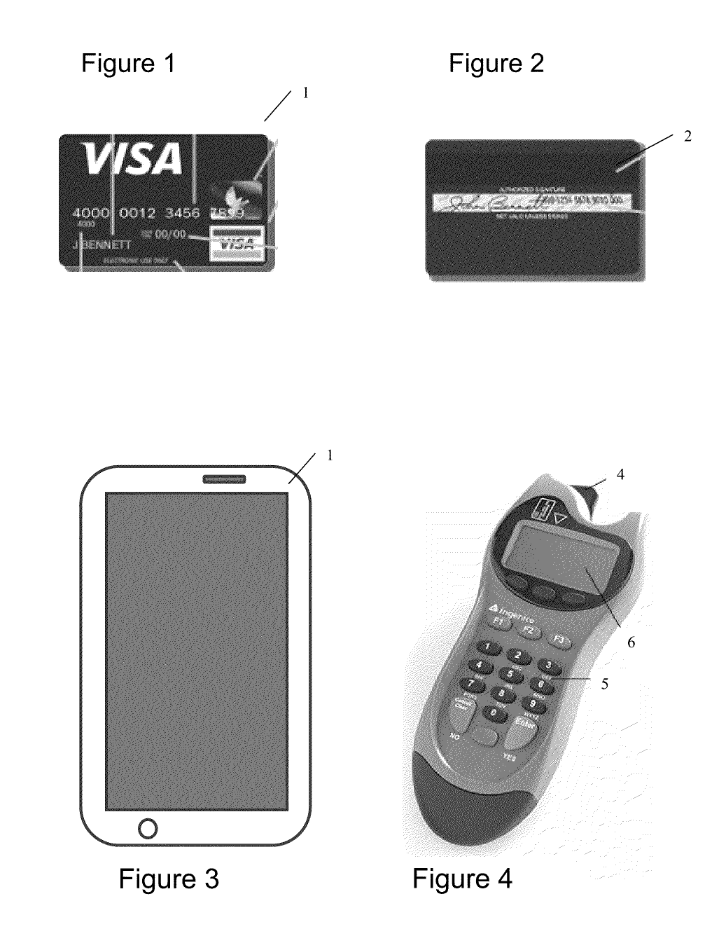

Preferred embodiments of the present invention are now described with reference to FIGS. 1 through 8.

### Payment Cards

Payment cards and devices 1 of the type shown in FIGS. 1 through 3 are well known. They are an embodiment of electronic money, the money which a person or holder already has (debit cards) or the money a person or holder borrows (credit cards). In a device these card may be held virtually in an ewallet. A typical credit card is shown in FIG. 1 (front view) and FIG. 2 (rear view).

Increasingly widely available, are payment devices 1 of the type which are commonly referred as Smart Cards or Chip Cards shown in FIGS. 1 and 2. These cards are also referred to as Integrated Circuit Cards (ICCs). These devices 1 as cards may have contacts 2 on the outside of the card through which a device reader 3 (for example a device payment terminal 3) may read data on the integrated circuit 2 (i.e. the chip) which is part of the device 1. Other forms of ICC may use radio communication so that physical electrical contact between the device 1 and the device payment terminal 3 is not required. Some ICCs may include a processor device in order to actively process instructions. Others may simply comprise a memory which can be assessed by a device payment terminal 3. References in this document to Integrated Circuit Cards, Chip Cards or Smart Cards are intended to include all ICC cards i.e. all payment cards which carry data in an integrated circuit provided on the card.

Such cards also readily lend themselves to inclusion in an ewallet on a device 1, for example a smart device, such as a phone or tablet as shown in FIG. 3.

The device 1 shown as a card in FIGS. 1 and 2 does not show contacts for connection with a reading device 3, but otherwise has the same general appearance as an ICC.

### Payment Terminals

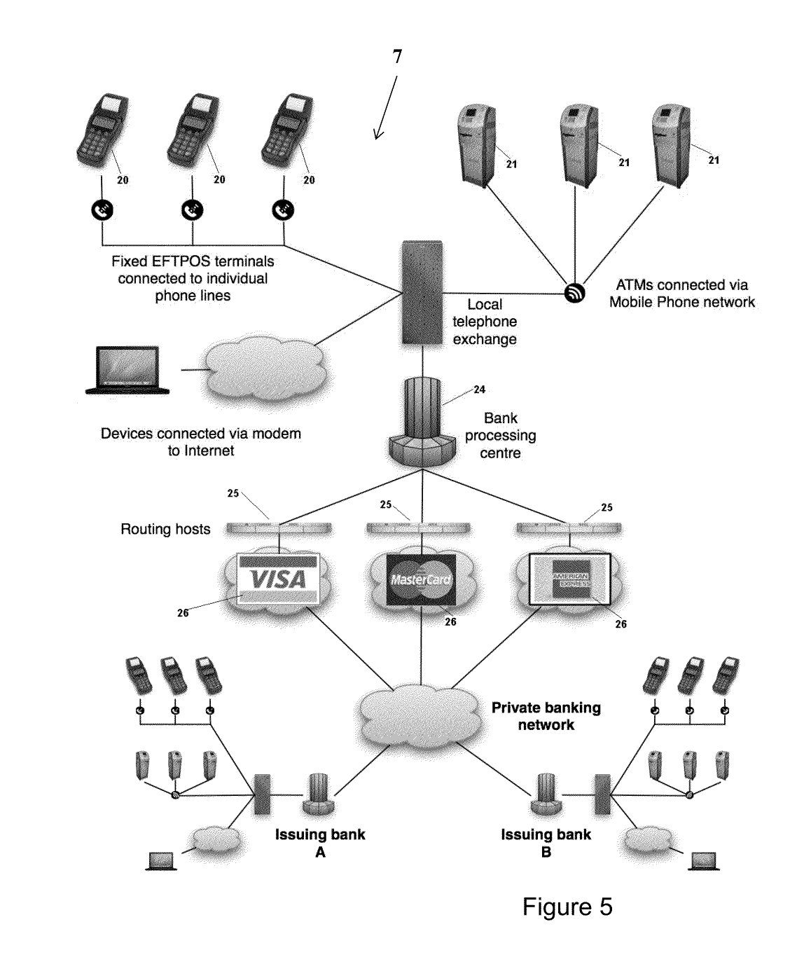

A typical device payment terminal 3 is shown in FIG. 4. It has an aperture or apertures 4 that allows the connection to the payment device 1. For example if the payment device 1 is a card then it can be swiped or “dipped”, so the card data can be read into the processing centre of the computer the device payment terminal 1 enshrines. The device payment terminal 3 may also have apparatus to allow wireless connection between it and the device 1. For example a physical card, or a virtual card held in an ewallet on a smart device. The device payment terminal 3 may take many forms and may be a unitary unit as shown, or may consist of two or more parts, which may or may not be tethered to allow communication and power. Modern payment terminals can communicate wirelessly, the radio link being the invisible “wire”, to enable communication with the payment network 7 (shown in FIG. 5).

In this document a payment terminal is not limited to a device having the physical appearance of the device shown in the picture. Any programmable computing device that has necessary input, output and remote communication mechanism, passes security requirements, and is approved by the acquiring bank or acquiring network (acquirer, please see below) will constitute a payment terminal.

The terminal 3 as shown also has a number pad (possibly two if two or more units form the terminal) and associated buttons 5. This is so that a user, for example a device holder, can key-in the device PIN number as a security check to facilitate the progression and management of payment transactions. Likewise the number pad can be used by the merchant to key in the amount and other details.

All these buttons, together with the device connecting by radio, swiping or dipping mechanism represent the “Input” of the payment terminal 3, not quite unlike the keyboard and mouse of a personal computer.

There is a LCD screen 6 built into this device 3 for displaying information. This screen represents the “output” of the payment terminal, again not quite unlike the screen of a personal computer. One of the functions of this will be described below.

### Merchant

Merchant, in the context of payment card business represents the agency that accepts a payment device as a mode of making payments, and has the means to handle such payments. The merchant will typically have a payment terminal 3 that includes a reader device that may be used by the device holder to perform a payment transaction with the merchant.

### Acquirer

Payment devices are issued and accepted globally. The merchant needs a local agency to handle all types of devices, regardless of their origin. They need a single agency to settle with them all their transactions. This role is filled by an acquirer, typically a bank. The merchant's payment terminal connects electronically with the local acquirer, and pushes all the device transactions into the acquirer's payment network for authorization and subsequent settlement (see below).

### Issuer

An issuer is a device scheme member, typically a bank that sells or issues cards or their virtual ewallet equivalent to individual customers, who then are device holders.

### Card Schemes

Card schemes like MasterCard and VISA are well known. They are responsible for creation of various schemes, specifications, processing networks, management of transaction operations, settlement of funds between different parties, enforcement of policies and procedures etc. They motivate banks and other financial businesses to become their members and sell card branded by them, either as physical cards themselves, or for inclusion virtually, for example an ewallet.

To ensure uniqueness of a card number at a global level, card schemes divide the total available set of numbers into different ranges or intervals, and allow members to issue card numbers within those intervals only. It is the issuing member's responsibility to ensure uniqueness within its own range. Typically a credit card scheme would use the most significant 6 digits (i.e. the first 6 digits of the card number) to manage allocation between its members, and leave the rest of the digits for the members to manage themselves. The six digit number, representing the most significant six digits of a payment card is called bank information number or BIN. Card schemes have been pre-allocated the first couple of digits, and they have to manage their BINs subject to this constraint. Thus VISA cards must begin with first two digits between 40 and 49, a MasterCard must begin with first two digits between 51 and 55. This still leaves the card schemes with tens of thousands of BINs for allocation amongst their members, and hundreds of thousands or millions of numbers are available against each BIN for allocation to payment card holders.

The actual card number is then printed and encoded on the card, and with other data onto its magnetic strip or chip, or the card number and data are loaded in an ewallet.

Card schemes regularly (typically annually) compile a directory of information about all the member banks and distribute it among them. These directories contain complete information about the name, location, contact details and allocated BINs for various members. BINs are always country specific and this is the rule. While a multinational bank may be issued multiple BINs for use in a particular country, it may not use a particular BIN in multiple countries.

### ISO 8583

ISO 8583 is the message exchange protocol that drives or underlies virtually all payment networks in the world. This protocol specifies exactly what kinds of transactions are possible, the parameters that need to be exchanged between various parties, the fields present for or on a card and how they should be formatted.

It is because of the presence of these fields that ISO 8583 based networks have always been capable of doing multi-currency transactions. This is the reason why it has always been possible to do currency exchange with payment card transactions using this standard, even if manually.

Acquirers don't always implement the entire specification on their local networks, primarily for economic reasons. However, in choosing their subset for implementation, they need to understand the entire specification to make sure the interface with the external global card scheme network doesn't break down. Each and every single item has to be thoroughly analyzed before inclusion or exclusion excluding in the local specification to make sure mandatory items don't get left out for global interfacing. This extends to what data fields they include or don't include, and which of those they include they populate, and in what form and how.

### Electronic Payment Network

A schematic organization (simplified version), of a global payment network 7 is shown FIG. 4. Payment terminals 20 and ATMs 21 (these may be the device payment terminal 3 described later) owned or licensed by banks are linked up with the bank's processing centre 24 via phone lines, or wirelessly as shown in the Figure. The bank's processing centre 2 links up with card scheme networks 26 via computers called routing hosts 25. The card scheme networks shown in FIG. 4 (as clouds) are typically collections of thousands of such routing hosts 25. These routing hosts 25 contain BIN versus issuer mappings; so that they can send different transactions to appropriate Issuers e.g. issuing bank A, issuing bank B (refer to the other end of cloud in FIG. 4, near the bottom). Once a transaction hits the issuer host, it is authorized there, and the result is sent back (via the card scheme network).

The collection of all payment terminals and ATMs linked up with a bank constitute the bank's local network. Three such networks are shown in FIG. 4. These networks link up with the global card schemes network via routing hosts as shown. Sometimes banks team up to create a joint local network, and joint interface with the global network, one example being ETSL (Electronic Transactions Services Limited) in New Zealand.

### Authorization and Settlement

Authorization is the process whereby a transaction request is sent to the card issuer, and an approval received. The idea is to establish availability of funds in the payment card account. It may be followed by a settlement request which results in the card holder account getting debited. The equivalent amount is paid by the issuer to the card schemes, who pay it to the acquirer who in turn pays it to the merchant. The card holder sees this debit in her (typically) monthly bill from the card issuer.

### How a Standard Payment Card Transaction Progresses

A standard payment card transaction progresses as follows:

The card is swiped, dipped or wirelessly connected (for an ICC card or for example a device with an ewallet) at the payment terminal 3 and card number and expiry are entered into terminal's processing area. If the magnetic stripe of the card is worn out, or the terminal swiper doesn't work, the card number and expiry date can be keyed into the terminal.

The amount of transaction is entered into the terminal.

The terminal casts the transaction information into requisite format and sends it to the acquirer.

The acquirer host looks at the card information, and determines the card scheme (as mentioned before, the first two digits of the card number contain this information).

The acquirer host pushes the transaction into the card scheme network.

The routing host in the scheme's network looks at the BIN of the card number, and identifies the issuer of the card (as noted before, since BINs are country specific, this identification embodies the country specific branch of the issuer, for example Citibank Hong Kong, or Citibank Australia etc, not just Citibank).

The card scheme network sends the transaction to the issuer host.

The issuer host checks to see if funds are available, and if “yes”, approves the transaction.

The issuer host sends the result of the transaction to card scheme network, which in turn sends it to the acquirer host, and it eventually reaches the merchant payment terminal.

The transaction result displays on the terminal 3, and the transaction receipt prints. The customer is asked to sign it as a means of authentication, unless he entered some kind of PIN number in the course of the transaction.

### Electronic Payment Networks

Electronic payment networks, from a computer perspective, link up and represent collections of a range of (human) user interface devices like EFTPOS devices, automatic teller machines (ATMs), web payment pages etc with transaction processing and accounting systems of payment card schemes like Visa and MasterCard and banks like American Express or Bank of New Zealand. The afore-mentioned human interface devices are collectively called terminal devices 3.

Terminal devices 3 could be real, as in case of ATMs which need to dispense cash, or virtual, like web payment pages. This distinction arises from the fact that for real devices, the terminal transaction management hardware and software is located locally, whereas for virtual devices, it is elsewhere on the network. A terminal device may have features from both varieties wherein part of the terminal side of transaction computing occurs on the device, the rest occurs elsewhere on the network (background devices). As noted above most real terminal devices (on electronic payment networks), regardless of size, shape and appearance, and background devices, are programmable electronic computers. Similarly most virtual terminal devices are driven remotely by programmable electronic computers.

The terminal devices manage human user interaction and electronic communications to capture all the information required for processing a transaction, send this information electronically to the card scheme or bank's accounting system, and convey the result to the human user at the end of the transaction.

### Preferred Embodiments of the Present Invention

The present invention does not require BIN or similar information to be stored in or at the hand held terminal, or be specifically retrieved by a request separate from the usual transaction process. Instead, a new method is provided which makes use of the standard data provided on the device 1 (either as a physical card, for example a credit card or virtually in a smart device, for example as part of a smart wallet, or ewallet—from hence forth card and its ewallet equivalent and therefore device are used interchangeably). This new method greatly simplifies the process and reduces the resources required by the payment terminal 3.

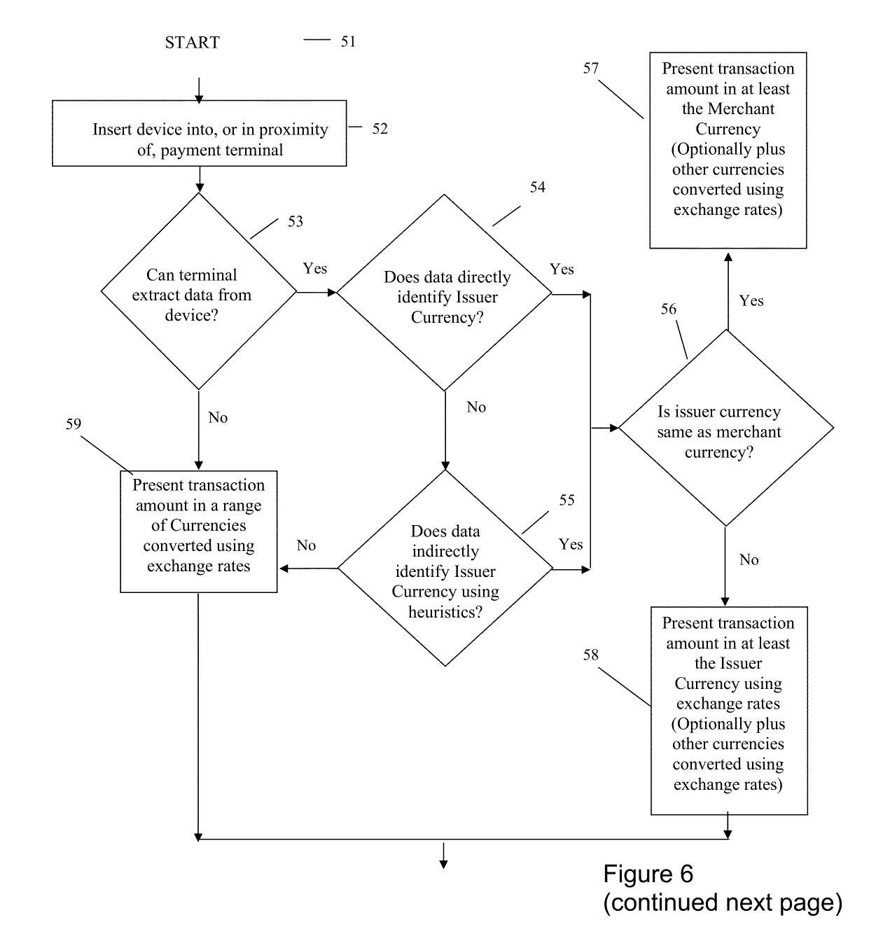

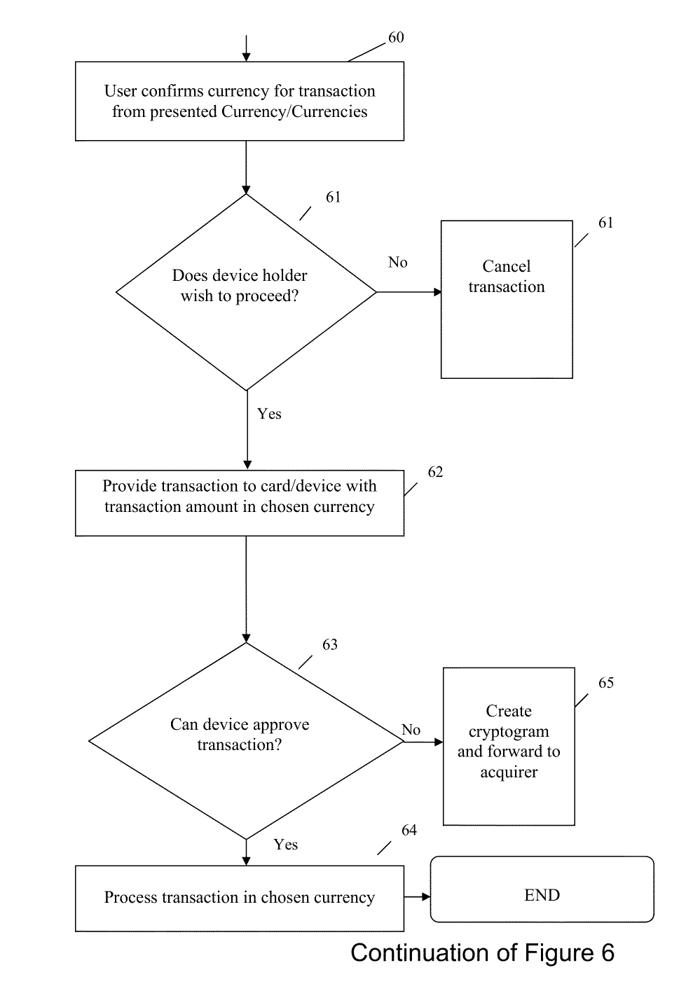

Referring to FIG. 6, a card (physical or virtual) transaction according to one example of the present invention will now be described. The transaction begins in step 51 when the card holder indicates a willingness to enter into a payment transaction with the merchant. In step 52 the card holder (or the merchant) allows the payment terminal 3 to read the payment device 1 (that is a real card or virtual card). This may occur by the device 1 being placed in sufficiently close proximity to the payment terminal 3, or may occur by having the card physically placed or “dipped” in the card reader device so that contact is made with terminals on the card as previously described. The payment terminal for example may be provided at a retail or shopping outlet.

Turning to step 53, the payment terminal 3 interrogates the card to obtain required data. This data will include the card number and possibly other data fields in connection with the present invention. The data fields are searched to locate in the preferred form the field or fields which relates to the card issuer currency, either directly or indirectly.

If the data field or fields is/are populated, then a decision is made at 54 as to whether the field(s) directly identify the issuer currency. For example, there may be an issuer currency field, or other fields that provide a direct indication of the card issuer currency. Those other fields may include country phone code, country geographical code, currency code, Currency name, Country name, Issuer name, Issuer Phone, Issuer Address, or Billing address or similar.

For example, apart from the card issuer currency being read directly, a card issuer telephone number may be read. The leading digits of the telephone number can be compared with international telephone dialing prefixes tabulated or mapped to a related country code. The country code can in turn be used to directly identify the appropriate currency, or cross check the issuer currency. Similarly, fields that relate to the country of the card issuer can be read to make a determination, or check, of issuer currency. For example, if a country name or code is returned, then this can be compared with a table of country names or codes that relates the names to a country (or directly to a currency) code.

If this information, which directly indicates the issuer currency cannot be detected from the card data then the method moves to a heuristic mode at 55. This is where data is retrieved from the card that is not directly indicative of the card issuer currency but which, depending on the way in which it is packed, organized or in which fields are filled in the card is indicative of the issuer bank or country. For example the way in which certain data is organized on the card will be typical of a particular bank or banks from a certain country. Therefore interrogation of this data and comparing this heuristically to known ways in which banks fill this data will then yield the country of origin of the device, and then the issuer currency can be determined. This heuristic in the preferred form of the invention may be run onboard the terminal 3 and so there is no need to step outside the environment of the payment device and the merchant device or terminal 3. In other less preferred forms the data may be sent externally of this environment, via a network to be heuristically analysed remotely at any of the levels shown in FIG. 5.

In the preferred embodiment of the invention the currency or other detail about the card or card user is identified by the use of heuristics. For example the currency information could be identified from data or operations which are in no way related to the currency or not even directly related to the card data and not obvious to a system user. Card issuers frequently implement different techniques to meet the various standard for when issued cards respond to transaction requests.

These techniques may include the information requested, the order of data requests or the authorisation required or packet combinations, or others as known in the art. The flexibility and variation possible in the way order or content of the fields in the card creates a “signature” of the issuer. Running heuristics on this combination of fields and their content allows this signature to be understood and then it is compared to the known issuer “signatures” to then determine the issuer's country or origin and therefore issuer currency.

Importantly these heuristics can exist solely between the payment device and the terminal (card reader), or may exist outside the terminal to the issuer bank or bank processing network, or other network. Periodically the terminal may have its heuristics updated (for example when its exchange rate data is updated, and may be manual or automatic) so the heuristics are always up to date with the latest known issuer signatures. In this way when a payment device is presented the terminal can run the heuristics within the environment of the payment device and terminal only, without having to go outside that environment (eg to a remote network) to then determine the issuer currency.

A heuristic approach within this environment therefore avoids the necessity to contact an acquirer or issuer network outside the environment and complications which may arise in this process, and also reduces network traffic. This may also be important as the details of the data on the card are not transmitted outside the environment of the payment device and terminal, so improving security. Instead, if the limited heuristics of the card/terminal transaction may be used an indication or solution to the country of origin or operation may be ascertained without referring to the issuer directly and while retaining all operations to the card and terminal.

Alternatively, or in addition the transactions between the terminal and bank processing system or issuer bank may also be applied to a heuristics engine to determine information or further information regarding the issuer bank, issue currency or other feature.

Therefore, from this information, the “home” or issuer currency of the card can be determined directly or indirectly by searching (directly) or analyzing (indirectly) selected data fields in the card data. From this data, the system makes a decision as to the issuer currency.

In steps 54 or 55 if the issuer currency is determined then issuer currency that has been is compared with that of the merchant currency at step 56. If the issuer and merchant currencies are the same, then the transaction processes in the normal way using the merchant currency as in step 57. At this step it is also optional to display a number of other currencies also that have been converted using exchange rates to the transaction amount. For example these may be the most commonly traded currencies, such as United States Dollar, European Euro, British Pound, Japanese Yen, Australian Dollar, Canadian Dollar, Swiss Francs, Hong Kong Dollars, Chinese Yuan, Korean Won, or Singapore Dollar. Alternatively, or in addition the most common currencies of the merchant region may also be displayed.

If the issuer currency is not the same as the merchant currency at 56, then also in step 56 the issuer currency is compared with a number of currencies that are supported by the acquirer. If the issuer currency is not supported then the transaction reverts up to the merchant currency in step 57.

If the issuer currency is supported and is not the same as the merchant currency then in step 56 the equivalent amount in the issuer currency is calculated, for example using a source of exchange rate between that issuer currency and the merchant currency. The amount at least in the issuer currency is then presented in step 58. This may be achieved in a number of ways, but is most conveniently performed at the payment terminal using exchange rate data in the payment terminal that is periodically updated with data relating to current exchange rates. This may come automatically from one or more exchange rate servers, or be entered manually, for example at the beginning of the trading day.

Again, at this step it is also optional to display a number of other currencies also that have been converted using exchange rates to equivalent transaction amounts. For example these may be the most commonly traded currencies, such as United States Dollar, European Euro, British Pound, Japanese Yen, Australian Dollar, Canadian Dollar, Swiss Francs, Hong Kong Dollars, Chinese Yuan, Korean Won, or Singapore Dollar. Alternatively, or in addition the most common currencies of the merchant region may also be displayed.

If through none of the steps 54 or 55 the issuer currency can be determined then the system will default to providing several pages of currency converted to the transaction amount at step 59. The user can then review these and choose the currency for the transaction. These may be sorted in several ways, for instance alphabetically, closest geographically or closest to the sensed issuer currency, if no exact issuer currency was detected.

By providing the merchant, issuer and other currencies converted into the transaction amount equivalent this will allow the user the greatest flexibility to complete the transaction.

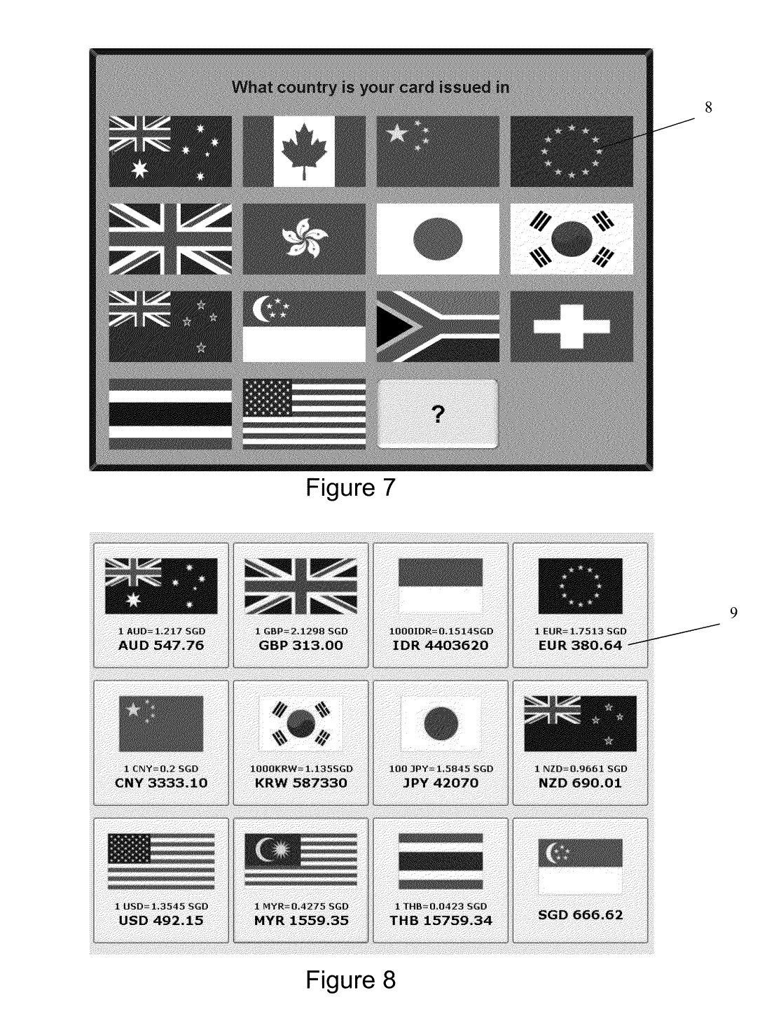

Beside each of the currencies displayed to the user is a graphic indicator 8 of that currency as shown in FIGS. 7 and 8. FIG. 7 shows for example the image that may be displayed to a user on the screen 6 of the payment terminal 3 from as a further optional step to allow the user to choose their country that issued their card (if automatic detection at steps 54 or 55 fails). FIG. 8 shows for example the image that may be displayed to a user on the screen 6 of the payment terminal 3 from steps 57, 58, or 59 with the optional additional currencies in addition to the merchant and issuer currency. It can be seen that under each currency graphic indicator 8 is the calculated equivalent to the transaction amount in that currency 9.

This, in the preferred form of the present invention will be the flag, emblem, logo or other graphic that is associated with that currency. In the preferred form this is displayed in colour to the user to provide maximum clarity.

Once the transaction currency has been chosen by the user at step 60 the transaction amount in the transaction currency are again displayed at 60 so the user can confirm they want to proceed with the transaction in the chosen currency at 61. The card holder or user may indicate approval by pressing a button on the payment terminal 3 for example. If the card holder does not wish to proceed, then the transaction is either cancelled at 62, or may loop back (not shown) to offer other currencies or is processed in the merchant currency in the usual manner.

If the card holder does wish to proceed with the transaction in the chosen currency, for example the issuer currency, then the system provides the transaction details including the transaction amount in the issuer currency to the card (whether actual or virtual) in step 62.

In step 63 the card/device must decide whether it can approve the transaction. If the transaction can be approved by the card, then the transaction proceeds in step 64 using the issuer currency. If the card/device cannot approve the transaction, then a cryptogram is created and transmitted to the acquirer for approval in step 65.

Therefore, the invention has the advantage that the issuer currency is located more quickly and with an enhanced degree of certainty over prior systems. Furthermore, the invention allows a DCC process to be integrated in a payment transaction which includes an ICC or equivalent device holding an ICC card (for example an ewallet), and provides the user with greater choice and quicker identification of currencies to complete the transaction. Use of such graphic indicators to identify the various currencies can be an advantage when the card holder is in a foreign country and could not read the country names in the foreign language. For example an English speaking person will not readily understand the characters in Japanese, Chinese or Korean languages. Whereas their own country flag for example will readily identify their currency. Further the graphic indicator provides faster visual recognition of the currency for the user.

The invention can be realized in a number of ways, on a number of platforms at a number of levels. As described the method can be implemented on a computer, and such computer may be the payment terminal 3, a direct connection to it, or a remote connection located on a host somewhere to which the terminal 3 is connected. The method may be embodied in a computer operated program which is supplied or transmitted for the purpose of installing on a computer or the like device for performing the steps of the method.

It should be noted that various changes and modifications to the presently preferred embodiments described herein will be apparent to those skilled in the art. Such changes and modifications may be made without departing from the spirit and scope of the present invention as set forth in the accompanying claims and without diminishing its attendant advantages. It is, therefore, intended that such changes and modifications be included within the present invention.

What we claim is:

1. A computer implemented method of performing a payment device transaction between a payment device holder and a merchant, the method comprising or including,
a. obtaining a transaction amount of the transaction in a merchant's currency,
b. obtaining,
i. an issuer currency from data present on said payment device, and if said issuer currency is not the same as said merchant currency, then obtaining an equivalent amount to said transaction amount in at least said issuer currency using at least one exchange rate source; or
ii. a range of payment currencies, if no said data can be extracted from said payment device, then obtaining equivalent amounts to said transaction amount in at least said range of payment currencies using at least one exchange rate source,
c. allowing a choice of transaction currency to be made for said transaction from a displayed currency or currencies, by displaying said transaction amount or equivalent amount(s) in any one or more of said,
issuer currency,
merchant currency, or
range of payment currencies,
wherein displayed against each said displayed currency or currencies is a graphic that uniquely identifies that currency.

2. A method as claimed in claim 1 wherein said graphic is chosen from any one or more of a,
a flag,
an emblem,
a logo,
that substantially uniquely identifies the country or countries of origin of said currency.

3. A method as claimed in either claim 1 or 2 wherein said graphic is a flag, or is derived from a flag, of the country of origin of said currency.

4. A method as claimed in any one of claims 1 to 3 wherein the step of obtaining said issuer currency relies only on said data present on said payment device, and does not need to contact a network outside of said payment device holder and a merchant's device.

5. A method as claimed in any one of claims 1 to 4 wherein, the step of obtaining said issuer currency uses data from said payment device that does not directly identify said issuer currency and subjects said data to heuristics to identify said issuer currency based on the way or ways in which said data is packed, presented, or otherwise, that is indirectly indicative of said issuer currency.

6. A method as claimed in any one of claims 1 to 5 wherein said graphic is displayed in colour for a user to choose from.

7. A method as claimed in claim 6 wherein said user is said payment device holder.

8. A method as claimed in either of claim 6 or 7 wherein said user is said merchant.

9. A method as claimed in any one of claims 1 to 8 wherein said payment device is any one or more of,
A payment card (whether credit, debit, or otherwise),
An Integrated Chip Card (“ICC”), or
Smartdevice (for example a phone, tablet, or similar).

10. A method as claimed in any one of claims 1 to 9 wherein in addition to said issuer currency and said merchant currency, one or more additional major currencies are shown to choose from, different to said issuer currency and said merchant currency.

11. A method as claimed in claim 10 wherein said additional major currencies are at least any one or more of the following,
United States Dollar,
European Euro,
British Pound,
Japanese Yen,
Australian Dollar,
Canadian Dollar,
Swiss Francs,
Hong Kong Dollars,
Chinese Yuan,
Korean Won, and
Singapore Dollar.

12. A method as claimed in any one of claims 1 to 11 wherein said step of obtaining said issuer currency includes the steps of searching said data for one or more predetermined fields and retrieving said data relating to one or more of said fields.

13. A method as claimed in claim 12 wherein said fields include at least any one or more of,
A country phone code,
A country geographical code,
A currency code,
Currency name,
Country name,
Issuer name,
Issuer Phone,
Issuer Address, or
Billing address.

14. A method as claimed in either of claim 12 or 13 wherein said step of obtaining said issuer currency includes the step of identifying the issuer currency from one or more of said fields that directly identify the issuer currency.

15. A method as claimed in any one of claims 1 to 14 wherein said range of payment currencies allows a user to scroll through numerous currencies in said equivalent amount until they find a said transaction currency they wish to use.

16. A method as claimed in any one of claims 1 to 14 wherein said method includes the step of allowing said device holder to confirm said transaction currency once chosen.

17. A method as claimed in any one of claims 1 to 16 wherein said method includes the step of still providing said transaction amount in the issuer currency to said device holder prior to receiving confirmation of said transaction from said device holder.

18. A method as claimed in any one of claims 1 to 18 wherein said method includes said device authorizing said transaction, or requesting authorization from an acquirer, which said acquirer will ultimately settle said transaction with said merchant.

19. A method as claimed in claim 18 wherein said method includes said device generating a cryptogram for forwarding to said acquirer for authorization.

20. A method as claimed in any one of claims 1 to 19 wherein said method includes the step of providing said device holder with an opportunity to instead proceed with the transaction in said merchant currency after said issuer currency has been selected as said transaction currency.

21. A method as claimed in any one of claims 1 to 20 wherein said method includes the step of providing said transaction amount to said device holder in said transaction currency prior to completion of said transaction.

22. A method as claimed in any one of claims 1 to 21 wherein said exchange rate source is updated automatically from at least one exchange rate server.

23. A method as claimed in any one of claims 1 to 22 wherein said exchange rate source is updated manually.

24. A computer implemented method of performing an Integrated Circuit Card (ICC) transaction between a card holder and a merchant, the method comprising or including the steps of:
a. obtaining a transaction amount of the transaction in a merchant's currency,
b. obtaining,
i. an issuer currency from data present on said ICC, and if said issuer currency is not the same as said merchant currency, then obtaining an equivalent amount to said transaction amount in at least said issuer currency using at least one exchange rate source; or
ii. a range of payment currencies, if no data can be extracted from said ICC, then obtaining equivalent amounts to said transaction amount in at least said range of payment currencies using at least one exchange rate source,
c. allowing a choice of transaction currency to be made for said transaction from a displayed currency or currencies, by displaying said transaction amount or equivalent amount(s) in any one or more of said,
issuer currency,
merchant currency, or
range of payment currencies,
wherein displayed against each said displayed currency or currencies is a graphic that uniquely identifies that currency.

25. A computer implemented method of performing a card transaction between a card holder and a merchant, the method comprising or including the steps of:
a. obtaining a transaction amount of the transaction in a merchant's currency,
b. obtaining,
i. an issuer currency from data present on said card, and if said issuer currency is not the same as said merchant currency, then obtaining an equivalent amount to said transaction amount in at least said issuer currency using at least one exchange rate source; or
ii. a range of payment currencies, if no data can be extracted from said card, then obtaining equivalent amounts to said transaction amount in at least said range of payment currencies using at least one exchange rate source,
c. allowing a choice of transaction currency to be made for said transaction from a displayed currency or currencies, by displaying said transaction amount or equivalent amount(s) in any one or more of said,
issuer currency,
merchant currency, or
range of payment currencies,
wherein displayed against each said displayed currency or currencies is a graphic that uniquely identifies that currency.

26. A computer operated program adapted to run on a computer device to perform a payment device transaction between a payment device holder and a merchant, the method comprising or including,
a. obtaining a transaction amount of the transaction in a merchant's currency,
b. obtaining,
i. an issuer currency from data present on said payment device, and if said issuer currency is not the same as said merchant currency, then obtaining an equivalent amount to said transaction amount in at least said issuer currency using at least one exchange rate source; or
ii. a range of payment currencies, if no data can be extracted from said payment device, then obtaining equivalent amounts to said transaction amount in at least said range of payment currencies using at least one exchange rate source,
c. allowing a choice of transaction currency to be made for said transaction from a displayed currency or currencies, by displaying said transaction amount or equivalent amount(s) in any one or more of said,
issuer currency,
merchant currency, or
range of payment currencies,
wherein displayed against each said displayed currency or currencies is a graphic that uniquely identifies that currency.

27. A computer device to implement a method of performing a payment device transaction between a payment device holder and a merchant, said computer device to carry out the following steps, comprising or including,
a. obtaining a transaction amount of the transaction in a merchant's currency,
b. obtaining,
1. an issuer currency from data present on said payment device, and if said issuer currency is not the same as said merchant currency, then obtaining an equivalent amount to said transaction amount in at least said issuer currency using at least one exchange rate source; or
i. a range of payment currencies, if no data can be extracted from said payment device, then obtaining equivalent amounts to said transaction amount in at least said range of payment currencies using at least one exchange rate source,
c. allowing a choice of transaction currency to be made for said transaction from a displayed currency or currencies, by displaying said transaction amount or equivalent amount(s) in any one or more of said,
issuer currency,
merchant currency, or
range of payment currencies,
wherein displayed against each said displayed currency or currencies is a graphic that uniquely identifies that currency.

28. A system for implementing a method of performing a payment device transaction between a payment device holder and a merchant, to carry out the following steps. comprising or including,
a. obtaining a transaction amount of the transaction in a merchant's currency,
b. obtaining,
i. an issuer currency from data present on said payment device, and if said issuer currency is not the same as said merchant currency, then obtaining an equivalent amount to said transaction amount in at least said issuer currency using at least one exchange rate source; or
ii. a range of payment currencies, if no data can be extracted from said payment device, then obtaining equivalent amounts to said transaction amount in at least said range of payment currencies using at least one exchange rate source,
c. allowing a choice of transaction currency to be made for said transaction from a displayed currency or currencies, by displaying said transaction amount or equivalent amount(s) in any one or more of said,
issuer currency,
merchant currency, or
range of payment currencies,
wherein displayed against each said displayed currency or currencies is a graphic that uniquely identifies that currency.

29. A method of performing a payment device transaction between a payment device holder and a merchant, the method comprising or including,
a. obtaining a transaction amount of the transaction in a merchant's currency,
b. obtaining,
i. an issuer currency from data present on said payment device, and if said issuer currency is not the same as said merchant currency, then obtaining an equivalent amount to said transaction amount in at least said issuer currency using at least one exchange rate source; or
ii. a range of payment currencies, if no data can be extracted from said payment device, then obtaining equivalent amounts to said transaction amount in at least said range of payment currencies using at least one exchange rate source,
c. allowing a choice of transaction currency to be made for said transaction from a displayed currency or currencies, by displaying said transaction amount or equivalent amount(s) in any one or more of said,
issuer currency,
merchant currency, or
range of payment currencies,
wherein displayed against each said displayed currency or currencies is a graphic that uniquely identifies that currency.

30. A system for performing an ICC card transaction between a card holder and a merchant, the system including one or more processors programmed and operable to perform the method as set forth in any one of the preceding claims.

31. A system for determining a transaction currency for an ICC transaction between a card holder and merchant, the system including one or more processors programmed and operable to perform the method as set forth in any one of the preceding claims.

32. A computer implemented method of performing a payment device transaction as herein described with reference to any one or more of the accompanying drawings.

33. A computer implemented method of performing an Integrated Circuit Card (ICC) transaction as herein described with reference to any one or more of the accompanying drawings.

34. A computer implemented method of performing a card transaction as herein described with reference to any one or more of the accompanying drawings.

35. A computer operated program as herein described with reference to any one or more of the accompanying drawings.

36. A computer device as herein described with reference to any one or more of the accompanying drawings.

37. A system for implementing a method of performing a payment device transaction as herein described with reference to any one or more of the accompanying drawings.

38. A method of performing a payment device transaction as herein described with reference to any one or more of the accompanying drawings.
